(19) United States
(12) Patent Application Publication
(10) Pub. No.: US 2007/0013603 A1
(43) Pub. Date: Jan. 18, 2007

(54) ANTENNA DEVICES AND PROCESSES FOR IMPROVED RF COMMUNICATION WITH TARGET DEVICES

(76) Inventors: Paul Atkinson, Poway, CA (US); Ronald S. Conero, San Diego, CA (US)

Correspondence Address: WILLIAM J. KOLEGRAFF, 3119 TURNBERRY WAY, JAMUL, CA, 91935, US

(21) Appl. No.: 11/457,431

(22) Filed: Jul. 13, 2006

Related U.S. Application Data
(60) Provisional application No. 60/699,411, filed on Jul. 13, 2005.

(51) Int. Cl. H01Q 1/40

(52) U.S. Cl. 343/873; 343/872; 343/702

(57) ABSTRACT

Devices and methods are provided for wireless communication with a target, such as an optical disc or an electronic device. The devices include an integrated processor and an antenna that are connected to the target, which enable a wireless communication with an associated reader or scanning system. The integrated circuit may be embedded in the target attached to the surface of the target, or in a label attached to the target. In a similar manner, the antenna may be embedded in the target, attached to the surface of the target, or in a label attached to the target. Interconnection lines may be used connect the integrated processor to the antenna, and may include a feedthrough arrangement for passing electrical signals between the surface and the interior of the target. A demodulator may also be positioned adjacent or on the antenna, allowing a long lead line to pass demodulated data to the integrated circuit. In one example, the antenna is positioned in or on a case that holds the target, with lead lines connecting the antenna to the target's integrated circuit. One, two, or three antennas may be used, with the multi-antenna arrangements preferably arranging the antennas orthogonally.

### RELATED APPLICATIONS

This application claims priority to U.S. patent application No. 60/699,411, filed Jul. 13, 2005, and entitled “Wireless Communication with Optical Discs”, which is incorporated herein in its entirety.

### BACKGROUND

1. Field

The present invention relates to circuits and processes for communicating with targets. More particularly, the invention relates to circuits and processes that enable an RF communication path to an IC associated with a target In one example, the RF-enabled target is an RF-enabled optical disc. The present invention also relates to antenna circuits and processes for wireless communication with targets.

2. Description of Related Art

Effective wireless communication with an article coupled to an RFID tag depends on interdependent variables, including the design and location of the antenna, transmitter/receiver (“transceiver”) and the integrated circuit (“IC”) that collectively comprise the tag; the placement and orientation of the tag with respect to the article and the reader; and the design and composition of the article. To maximize signal reception, for example, it is desirable for the antenna to be oriented in a geometric plane perpendicular to that of the RF signal transmitted by the reader. Further, it is desirable for the antenna to be positioned relative to the article such that the article does not interfere with the signal path between the article and an external reader.

Optical discs (e.g. CD's, DVD's etc.) present a particularly complex challenge for RFID tag communication when such discs are stacked in packages for shipment or on retail shelving. Because of their required geometries, RFID antennas are typically located in the same plane as the disc. An optical disc however is comprised of reflective layers of thin metal that span most of the plane of the disc and act as reflectors and attenuators of RF energy transmitted and received by readers. A standard shipping carton containing 30 movies each for example can have as many as 120 layers of metal (2 discs per case, dual layer discs) and 30 RFID tags.

### SUMMARY

Improved devices and systems for allowing communication between a device with data processing capabilities and a reader are provided to solve the foregoing problems associated with RFID tags and other devices capable of RF communication.

Briefly, the present invention provides devices and methods for providing wireless communication with a target, such as an optical disc or an electronic device. The devices include an integrated processor and an antenna that are connected to the target, which enable a wireless communication with an associated reader or scanning system. The integrated circuit may be embedded in the target, attached to the surface of the target, or in a label attached to the target. In a similar manner, the antenna may be embedded in the target, attached to the surface of the target, or in a label attached to the target Interconnection lines may be used connect the integrated processor to the antenna, and may include a feedthrough arrangement for passing electrical signals between the surface and the interior of the target. A demodulator may also be positioned adjacent or on the antenna, allowing a long lead line to pass demodulated data to the integrated circuit. In one example, the antenna is positioned in or on a case that holds the target, with lead lines connecting the antenna to the target's integrated circuit. One, two, or three antennas may be used, with the multi-antenna arrangements preferably arranging the antennas orthogonally.

In one example, an integrated circuit is embedded in an optical disc, and couples to an antenna. The optical disc may be, for example, a DVD, CD, DVD-9, Blu-ray disc, HD-DVD, or game disc. The disc may also be a pressed or prerecorded media, or may be writeable or rewritable media. The antenna may also be embedded, or may be on the surface of the disc, in a label attached to the disc, or spaced apart from the disc. For an antenna external to the disc, conductive feed-throughs are used to pass signals from the surface of the disc to the embedded processor. The feed-throughs may directly connect to the antenna, or a lead line may be used to allow the antenna to be more flexibly positioned. For example, the antenna may be located in or on the case holding the optical disc. For longer lead lines, a demodulator may be used adjacent the antenna, which allows demodulated data to pass to the integrated circuit. In a specific example, the wireless communication is an RF communication at an RFID or near field communication frequency.

In another example, an antenna is embedded in an optical disc, and couples to an integrated circuit. The optical disc may be, for example, a DVD, CD, DVD-9, Blu-ray disc, HD-DVD, or game disc. The disc may also be a pressed or prerecorded media, or may be writeable or rewritable media. The integrated circuit may also be embedded, or may be on the surface of the disc, in a label attached to the disc, or spaced apart from the disc. For an integrated circuit external to the disc, conductive feed-throughs are used to pass signals from the surface of the disc to the embedded antenna. The feed-throughs may directly connect to the integrated circuit, or a lead line may be used to allow the integrated circuit to be more flexibly positioned. For example, the integrated circuit may be located in the clamping area of the optical disc. In a specific example, the wireless communication is an RF communication at an RFID or near field communication frequency.

A target, such as an optical disc, which has an associated integrated circuit, may be placed in a holding case. An antenna may be placed in or on the case, and coupled to the integrated circuits using lead lines. The case has contacts that enable the antenna to connect to the integrated circuit when the case is closed. The antenna may be in or on the spine of the case, an edge of the case, or the front or back cover to the case. In another arrangement, a second antenna may be positioned in or on the case, and is preferably orthogonal to the first antenna when the case is closed. In another arrangement, a third antenna may be positioned in or on the case, and is preferably orthogonal to both the first and second antenna when the case is closed. In a specific example, the wireless communication is an RF communication at an RFID or near field communication frequency.

Advantageously, the integrated circuit and its antenna system may be flexibly arranged to meet communication specifications for diverse applications, and also may be adapted to meet manufacturing and distribution requirements. In this way, the integrated circuit and its antenna system enabled robust wireless communications between a scanning system and an optical disc, and may be adapted according to specific application needs.

### BRIEF DESCRIPTION OF DRAWINGS

These and other features, aspects and advantages of the present invention will become better understood with regard to the following description, appended claims, and accompanying figures where:

FIG. 1 is an illustration of beam reflection and attenuation when reading multiple discs carrying embedded processors.

FIG. 2 is a cross-sectional view of an optical disc showing the structure of the disc and illustrating the detection of data from the disc with a laser.

FIG. 3 is a top plan view of an optical disc showing different features of the disc.

FIG. 4 is a cross-sectional view of an optical disc and a polycarbonate ring with an antenna on it adapted to be located in a matching recess in the optical disc.

FIG. 5 is an exploded cross-sectional view of an antenna and an IC bonded to a layer of an optical disc, prior to the final bonding of the layers of the disc.

FIG. 6 is a cross-sectional view of an optical disc having an external antenna located on the surface of the disc as part of a label applied on the surface of the optical disc.

FIG. 7 is an illustration showing the attachment of a label with an antenna to an optical disc.

FIG. 8 is an exploded cross-sectional view of an optical disc illustrating how an IC can be coupled from the interior of an optical disc to the outer surface via conductive feed-throughs and contacts.

FIG. 9 is a right perspective view of an optical disc and a case for the optical disc illustrating the placement of an antenna in the optical disc case for coupling to a device in the optical disc.

FIG. 10 is a right perspective view of the optical disc and case of FIG. 9 after the optical disc has been placed in the case.

FIG. 11 is a right perspective view of an alternative case for an optical disc having a ¼ folded dipole antenna located on a side edge of the case.

FIG. 11A is a perspective view of an alternative case for a target, such as an electronic device.

FIG. 12 is a left perspective view of stacked optical disc cases containing antennas located on their edges.

FIG. 13 is a right perspective view of an alternative case for an optical disc having a ¼ folded dipole antenna located on a top or bottom edge of the case.

FIG. 14 is a right perspective view of an alternative case for an optical disc having a ¼ folded dipole antenna located on the lower inner face of the case.

FIG. 14A is a right perspective view of an alternative case for an optical disc.

FIG. 14B is a right perspective view of an alternative case for an optical disc.

FIG. 15 is a diagram showing multiple antennas for an IC having shared demodulated output.

FIG. 16 is a top plan view of a dual antenna for an IC applied to a planar surface.

FIG. 17 is a perspective view of the dual antenna of FIG. 16 folded at a right angle along the dotted line shown in FIG. 16, for application to a substrate having surfaces which meet at a right angle.

FIG. 18 is a right perspective view showing the application of a dual antenna as shown in FIG. 17 to an optical disc and optical disc case.

FIG. 19 is a top plan view of a triple antenna for use with an optical disc.

FIG. 20 is a right perspective view of the triple antenna of FIG. 19 folded along the dotted lines shown in FIG. 19.

FIG. 21 is a right perspective view of the triple antenna of FIG. 20 applied to a carton.

FIG. 22 is a right perspective view of a triple antenna associated with an optical disc and optical disc case.

FIG. 23 is a right perspective view of a triple antenna associated only with a case for an optical disc.

FIG. 24 is a diagram of an IC for use with the embedded antenna on a disc shown in FIG. 18.

FIG. 25 is a diagram illustrating the use of an IC with both local and remote antennas.

All dimensions specified in this disclosure are by way of example only and are not intended to be limiting. Further, the proportions shown in these Figures are not necessarily to scale. As will be understood by those with skill in the art with reference to this disclosure, the actual dimensions of any device or part of a device disclosed in this disclosure will be determined by their intended use.

### DETAILED DESCRIPTION OF THE INVENTION

Detailed descriptions of examples of the invention are provided herein. It is to be understood, however, that the present invention may be exemplified in various forms. Therefore, the specific details disclosed herein are not to be interpreted as limiting, but rather as a representative basis for teaching one skilled in the art how to employ the present invention in virtually any detailed system, structure, or manner.

It is desirable in some instances for an IC associated with an RFID tag to be embedded in a target so that it can not be readily accessed or removed by would-be thieves. To maintain effective communication with a reader however, it is often desirable to place the antenna external to the target and communicatively couple it to an IC embedded within the target. These desirable conditions are often in conflict with each other and often necessitate that product designers make tradeoffs that significantly affect the performance of the system or increase design and product costs.

Reader arrangements 10 are shown in FIG. 1. The arrangement 10 has a set of sets 14, with each disc having an associated antenna and IC. The discs may be, for example, DVDs, CDs, DVD-9s, Blu-ray discs, HD-DVDs, or game discs. The discs may also be a pressed or prerecorded media, or may be writeable or rewritable media. The first disc 16 is shown with an integrated circuit 23 and an antenna 25. In one arrangement, a reader A 12 positioned along the axis of multiple discs 14 where the RF signal can only reach the first disc 16. All the other antennas on the rest of the discs in the stack 14 are either shielded by the antennas of all the discs in front of them, or by the reflective layers of all the discs in front of them. Reader B 21 is positioned at a right angle to the axis of the multiple discs 14. Energy from its antenna either passes right through the gaps between the discs, or hits the edge of the reflective layers in the discs. The energy that might actually reach the edge of the antenna is not effective, because the antenna has a null response at a right angle to its plane.

Definitions

As used herein, the following terms and variations thereof have the meanings given below, unless a different meaning is clearly intended by the context in which such term is used.

“Activate” refers to the enabling of a target to provide a feature, in particular a functional or other beneficial feature, or to allowing access to such a feature, by an IC. Activation can also refer to a change to a target that is instructed or made by the IC, in particular a change which gives the target a utility that it didn't have prior to activation. For example, activation of a target can comprise allowing a user access to content stored in the target, such as information stored on an optical disc. “Deactivate” refers to rendering a feature of a target inoperative, so that the feature cannot be used or accessed, and/or to returning a target to the state or condition it was in prior to activation. Both activation and deactivation are generally reversible. In addition, the signals and/or codes instructing an IC to activate or deactivate a target are preferably communicated in a secure manner in order to control such activation or deactivation, so that only conditional access to a controlled feature of a target is allowed.

“Authenticated event” or “AE” refers to an action performed by an IC in response to a command issued to the IC in a secure manner, such as through the use of a password system, PKI, or the methods described above. Authenticated events can be, for example, the activation or deactivation of a feature of a target, the permanent disablement of the ability of an IC to activate or deactivate such feature, or the verification of the identity of the target.

“Conditional access” refers to access to a target or to a feature of a target, in particular an attribute which confers utility or value, under the control of a device with data processing capabilities such as an IC. The processor allows or denies access to such feature by activating, deactivating, or otherwise affecting the target or a feature thereof. Such access is preferably provided in a secure manner.

“Conditional access network” refers to a system comprising, at a minimum, a NOC, reader, IC, and target. The components of a conditional access network operate together to provide secure communication between a reader and an IC, and in particular to provide conditional access to an IC and/or to the target (or a feature thereof) with which the IC is in communication. The systems and devices disclosed herein can be used together with a conditional access network.

“Disable,” with regard to RFA ICs, refers to rendering a RFA IC permanently incapable of activating, deactivating, or performing some other action with respect to the target with which it is in communication.

“Fusible Link” refers to a portion of a circuit in a IC which becomes permanently disabled, i.e. unable to carry current, when the current-carrying capacity of the Fusible Link is exceeded. It will be understood that other devices may be used to permanently transition from a first state to a permanent second state, such as a partial fuse or an anti-fuse.

“IC” refers to an electronic device which has data processing capabilities and an interface for communicating with other devices via electromagnetic signals, preferably RF signals. ICs are also in communication, preferably electrical communication, with a target. ICs can be directly attached to a target, such as by being embedded in a target, or can be attached to another article which is itself attached to the target. ICs typically comprise a silicon die containing integrated circuitry, with gold plated pads for wire connections to such circuitry. This form of the IC is often called a “die” or “chip” which are typically housed in “package” that can be fabricated from metal, plastic, or ceramic. The package protects the delicate die or chip and the associated bond wires, and it provides a standard way of making connections. Both packaged and raw or unpackaged dies with suitable connection means can be used. The term “embedded processor” or EP used in other provisional patent applications filed by Kestrel Wireless has the same meaning as that given to IC herein.

“Network Operations Center” or “NOC” refers to a facility for communicating with an IC, such as via a reader, and with a device running a load center application. The NOC comprises a server, computer, or other device having data processing capability and the ability to communicate with the IC and load center, preferably via a network connection. Functions of the NOC can be distributed over multiple locations and/or devices.

“Reader” refers to a device which provides an input signal, preferably an electromagnetic signal, to a RFA IC or other IC. If a RFA IC emits an electromagnetic signal in response, the reader is preferably configured to receive and process such signal. The overall function of a reader is to provide the means of communicating with RFA ICs and facilitating data transfer to and/or from RFA ICs.

“RF” refers to radio frequency energy.

“RFA IC” and “radio frequency activated integrated circuit” refer to refer to an IC having an interface for receiving input signals from a reader, which is also preferably capable of providing output signals to a reader. Radio frequency signals are preferred for the input interface but other types of signals, including electromagnetic signals of other frequencies, are also possible. RFA ICs are in communication with a target and also have an output interface to effect a change in a target. The RFA ICs described herein typically include a Fusible Link and other circuitry for permanently disabling the ability of an RFA IC to perform functions such as activating or deactivating a target. RFA ICs can be active, i.e. powered by a battery or other power source, but preferably are passive and obtain operating power from signals sent by a reader, without a separate external power source. RFA ICs can be manufactured in ways known to the art for producing integrated circuits for RFID tags and similar devices.

“Target” refers to an article, item or media on or to which an IC is to perform an action. Targets can be, for example, media for storing content such as audio, video, images, codes, and other types of data and information, in particular optical media such as compact discs (CDs), video discs, digital versatile discs (DVDs), laser discs, or holograms. Alternatively, the target can be an electronic device. ICs are typically embedded in a target.

As used herein, the term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise.

RF Devices

Various IC devices makes use of RF frequency energy to communicate. Such devices are frequently referred to as RFID tags or similar designations. Such RF devices can be thought of as comprising three basic elements: an IC, an RF transmitter/receiver (“transceiver”) and an antenna. The antenna is typically electrically coupled to the IC through the transceiver. The functions of such devices are conventionally integrated into a single physical entity, but as described herein they can be distributed among multiple entities and in different configurations. For example, the antenna, transceiver and IC can all be embedded in a target, or the antenna can be coupled to an IC embedded in the target using appropriate mechanical and electrical connection means. In the latter configuration, the transceiver can be located with either the antenna or the IC. Typically, the IC is embedded in a target in the present systems. Various configurations of the foregoing elements are possible, such as multiple antennas coupled to a single IC, or multiple ICs configured to a single antenna.

RFA ICs are similar to an RFID tags, but are enhanced with elements not found in typical RFID tags. For example, RFA ICs generally include logic, memory and an output interface distinct from the RF interface to effect changes to a target to which it is coupled (e.g. to activate or deactivate the target to which it is coupled).

In most instances radio frequency communication is the preferred method of wireless communication between a reader and a target. Standard RF frequencies used in RFID applications are typically 13.56 MHz, 900 MHz ISM band, or 2.4 GHz. Although any frequency can be used, the 900 MHz ISM band is well suited for the present applications for reasons of antenna size, RF communication range, and minimal interference from other RF sources. Although the RF frequency energy shall be referred to throughout the present description, other electromagnetic frequencies are also possible. Therefore, references to RF (e.g., RFID, RFA IC, etc.) shall be understood as encompassing the use of other frequencies of electromagnetic energy unless otherwise noted, or unless other frequencies would not be feasible in a particular embodiment.

ICs and Antennas

Optical discs are one type of target for which the present systems are useful. However, it should be understood that the present systems are not limited to optical discs and that they are applicable to a wide range of targets. Content stored in an optical disc is read by reflecting a laser light off metalized data structures within the disc (one or more thin layers of metal that are deposited onto the surface of binary patterns molded into polycarbonate). Patterns in the reflected light are detected by an optical drive as the disc is rotated and are then translated into digital signals appropriate to the host device (e.g. computer, player or game console).

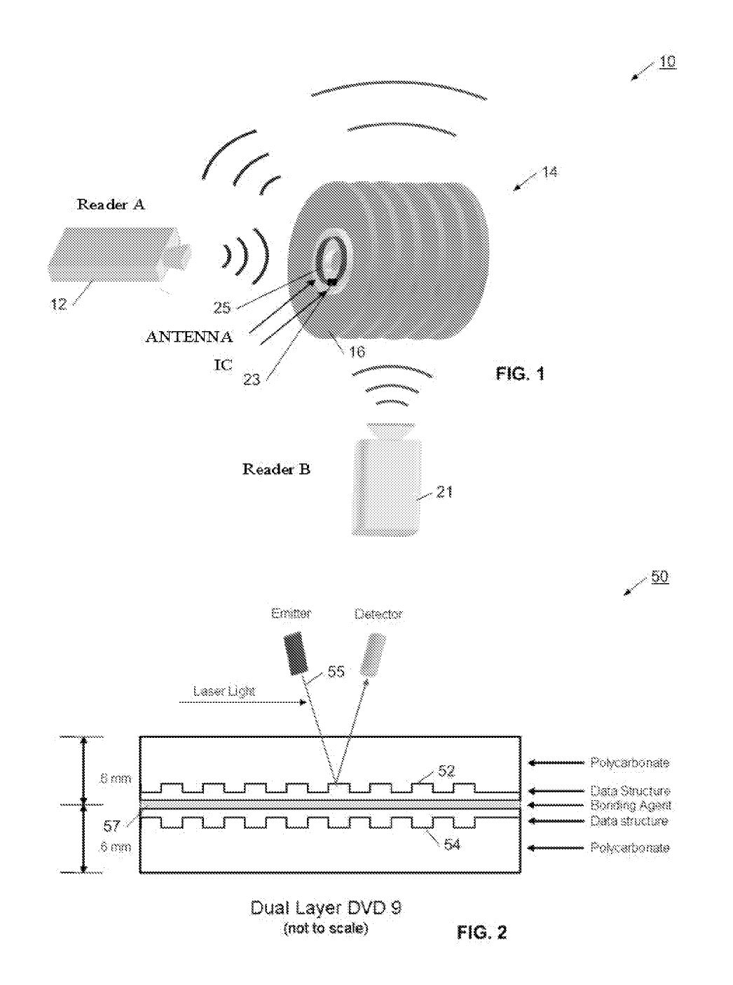

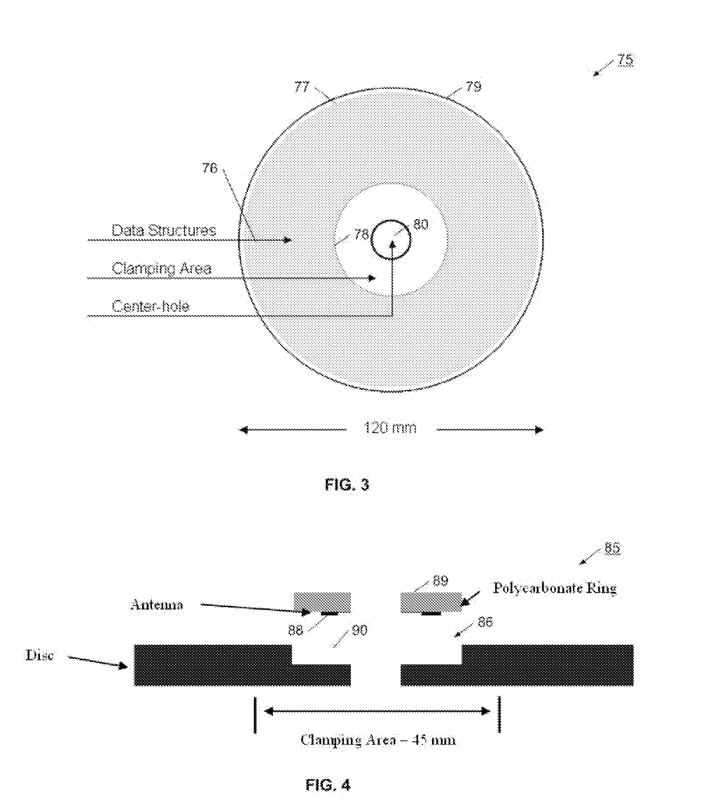

FIG. 2 illustrates an optical disc 50 having two data structures 52 and 54 (reflective layers of thin metal) commonly referred to as a DVD 9. The interrogating laser light 55 can be focused on, and thus reflected by, either layer (the reflective layer nearest the emitter is effectively transmissive when the laser is focused on the layer farthest from the emitter.) The two halves of the disc are manufactured independently and then bonded 57 together to form a complete disc. As shown in FIG. 3, the data structures 76 cover an area bounded by two concentric circles 77 and 78. The outer circle 77 is typically 1 mm from the outer edge 79 of the disc 75 while the inner circle 78 is typically 15 mm from the center-hole 80 of the disc 75.

It is often desirable for the IC to be embedded in the optical disc. This ensures that the ID and any information contained within the IC are unequivocally associated with the particular disc to which it is embedded (as opposed, for example, to the case in which it is packaged). It also ensures that it can not be removed and that it can be coupled to other elements in the disc required, for example, to affect conditional access or activation.

ICs and Antennas in the Clamping Area of a Disc

To avoid interfering with the data structures in the disc, it can be desirable to locate the IC in the clamping area 86. This can be accomplished by embedding the IC in the polycarbonate substrates when the disc is molded or after the substrate is created and placing it in a space formed during the molding process or created afterwards (e.g. by laser drill, pressed indentation etc.).

Independent of the exact location of an IC embedded in the disc, it can be desirable to locate the antenna 88 in the clamping area 86 of the disc, as illustrated in FIG. 4. This approach has the advantage of not interfering with the ability to read or write data from or to the disc and of minimizing signal interference due to the metallized data structures in the disc. In some situations, the metalized layer of the data structure can be useful as a ground plane for the actual antenna. This may depend upon the frequency being used for RF communication to the IC as well as the specific geometry of the antenna.

There are several ways that an antenna can be located in the clamping area. The antenna can be constructed out of conductive ink that is screened or sprayed on a surface of the polycarbonate substrate, including surfaces that are subsequently sealed or covered, e.g. when the two halves of the disc are bonded together. The antenna can be constructed out of metal that is directly deposited on the polycarbonate substrate of the optical disc. A foil antenna can also be pressed directly onto the polycarbonate substrate (e.g. on the side of the substrate to be bonded) or applied using an adhesive. A polycarbonate ring 89 or other suitable material with the antenna 88 already on it can be located in a matching recess 90 in the optical disc 85 as shown in FIG. 4 (not to scale). In all of these implementations, the antenna can be located inside the optical disc, or on the surface of the optical disc.

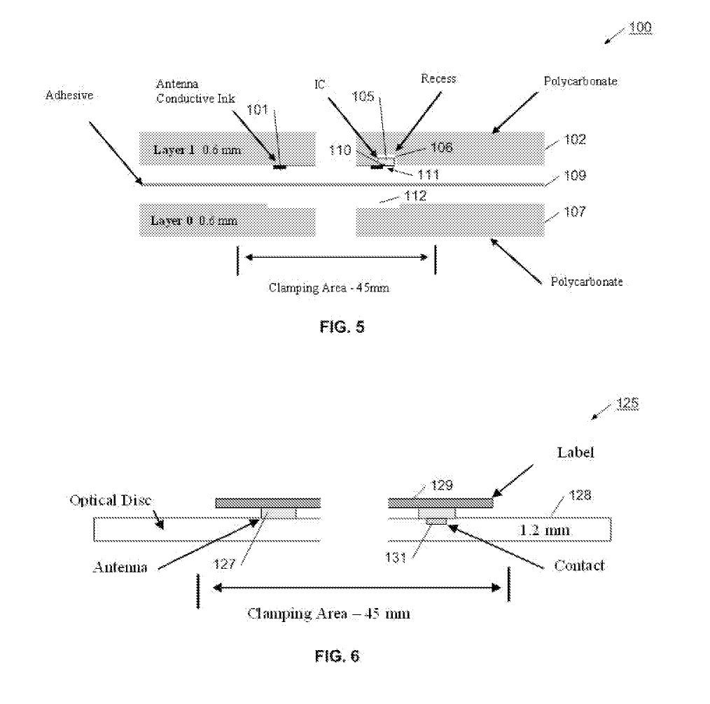

FIG. 5 shows a cross section of an antenna 101 bonded to Layer 1 102 of the disc 100 along with the IC 105 which is then bonded to Layer 0 105 of the disc 100 to make a complete disc. The IC 105 is located in a recess 106 in Layer 1 102 which can be pre-molded in the polycarbonate. The IC 105 can be held in place by any number of techniques, including a bonding agent or adhesive such as that used to bond the two halves of a DVD that hardens when exposed to ultraviolet light.

The antenna 101 along with the IC 105 is completed encapsulated within the disc 100 once the two halves are bonded together with the adhesive 109. The IC 105 can be mounted in the recess 106 with the contacts 110 toward the adhesive layer 109. The antenna 101 circuit, which can be screened conductive ink, overlaps 111 these contacts 110 to make connection to the IC 105. A slight recess 112 in layer 0 107 accommodates the thickness of the antenna 101.

It can be desirable to mount the IC in a recess in Layer 0. This can be easily accomplished by changing the molds for the polycarbonate blanks for layer 0 and layer 1.

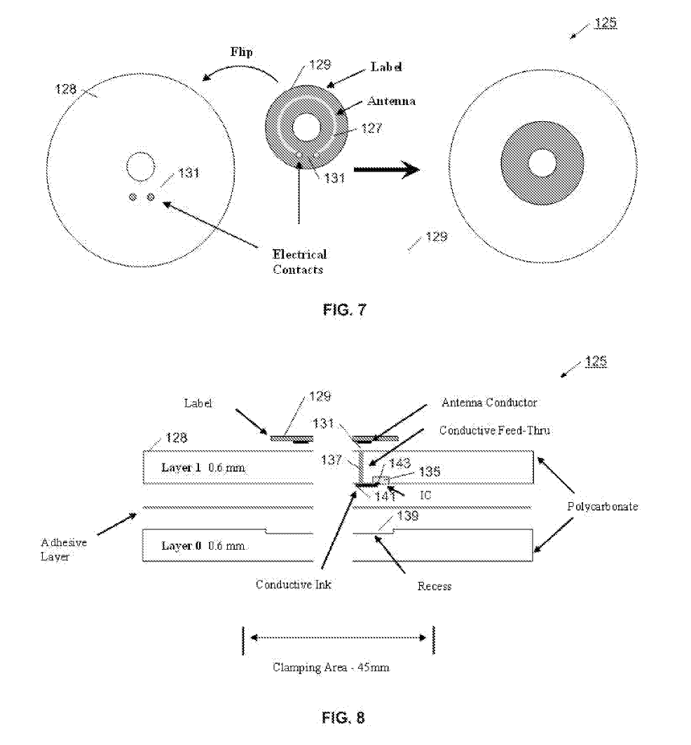

Referring to FIGS. 6 and 7, an external antenna 127 can also be located on the surface 128 of the disc 125, configured for example as part of a label 129 that is applied on the surface 128 of the optical disc 125 as shown in FIG. 6. In this example, the antenna 127 is part of, or combined with, a label 129 with conductors that form the antenna 127 circuit and contacts 131 located on the ventral side. The label 129 can then be adhesively attached to the surface 128 of the optical disc 125. Electrical connections to the antenna 127 are made via direct electrical contact to mating conductive pads on the surface of the optical disc 125 as shown in FIGS. 6 and 7.

FIG. 8 shows a detailed view of how an IC 135 can be coupled from the interior of the optical disc 125 to the outer surface 128 via conductive feed-throughs 137 and contacts 131. The IC 135 can, for example, be embedded in a recess 139 in the optical disc 125. Conductive ink 141 can be screened on the lower surface of Layer 1 to make a connection between the IC contacts 143 and the conductive feed-through 137. The feed-through 137 can be either a plated hole in layer 1, or alternately can be an insert molded metallic pin. The feed-through 137 brings the IC 135 circuit to the top 128 of layer 1 where it can make direct electrical contact with the antenna contact 131 on the label 129. If the feed-through 137 is a plated hole, it can be filled with a conductive epoxy that fills the hole and prevents water vapor or gases from penetrating the disc 125 and causing lamination failures. In the case of the insert molded pin, it is unlikely that moisture or gases would penetrate the junction of the pin and the polycarbonate, but these joints can be sealed by the application of a thin circular layer of conductive epoxy on the surface of the disc / pin which is slightly larger than the diameter of the feed-through 137. This conductive epoxy serves a secondary function of making a robust connection to the antenna 127 contacts.

In different implementations, the antenna can be adhesively attached such that it is permanent, i.e. cannot be removed without damaging the substrate to which it is attached, or it can be removed by the customer after the activation process has occurred. This can occur through a direct action by the customer (e.g. manually pulling a label to which an antenna is attached off the disc), or it can be achieved automatically when the case containing the optical disc is opened and/or the optical disc is removed from the case. For example, the label with the antenna can be located on the bottom of Layer 0, which is always inserted down in the case. The adhesive that holds the label / antenna to the disc can allow the label to easily be pulled off. The back side of the label which contacts the inside of the case can be coated with a very aggressive adhesive, such as an acrylic adhesive. When the customer removes the disc from the case after activation, the label and antenna peel away from the disc and remain in the case. In a second example, the label with the antenna can be located on the top of Layer 1, which is always inserted up in the case. The adhesive that holds the label / antenna to the disc can allow the label to easily be pulled off. The top side of the label which contacts the inside of the case cover can be coated with a very aggressive adhesive, such as an acrylic adhesive. When the customer opens the case after activation, the label and antenna peel away from the disc and remain in the top cover of the case. The use of removable antennas can address consumer concerns about privacy and can be desirable from a marketing perspective.

The antenna may also be directly attached to the surface of the disc. For example, the antenna may be disposed on the surface using known deposition processes, or through an ink-jetting process that disposes a conductive ink in the form of an antenna pattern. The antenna may also be constructed of a foil or metal and be embedded in the surface, or adhered with an adhesive.

Antennas Associated with Cases

In another embodiment, an antenna can be located in or on packaging, such as a case that holds or contains an optical disc. The antenna can be electrically coupled into the disc via any number of methods, including but not limited to direct electrical connection via contacts, capacitive coupling via conductive pads or plates, magnetic coupling via coils or conductors, or any other appropriate method compatible with the RF carrier and modulation frequencies.

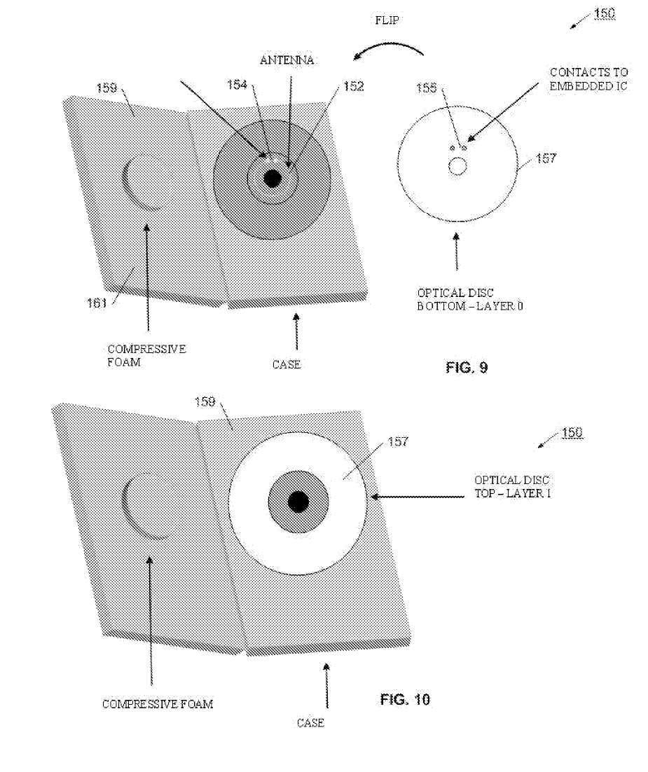

One example of this embodiment 150 is shown in FIG. 9. In this example, the antenna 152 is in the case and is shown as a ¼ wave loop design with electrical contacts 154. However, any appropriate antenna geometry can be used. The contacts 154 interface to mating contacts 155 on the bottom of the optical disc 157 when it is present in the case 159. A compressive foam 161 or other suitable material can be located in the top of the case 159 to provide pressure across the set of contacts in order to ensure good electrical connection when the case cover is closed. Note that the antenna 152 itself can be located on the case 159 and visible to the customer when the optical disc 157 is removed, or can be embedded within the case 159 and not visible. In both cases the contacts 154 will be visible when the optical disc 157 is removed from the case. If capacitive or inductive coupling is used, direct connection is not required, and even the contacts can be embedded in the case along with the antenna, so that the case appears normal to the customer when the optical disc is removed. FIG. 10 shows how the disc 157 will appear when installed in the case 159 shown in FIG. 9.

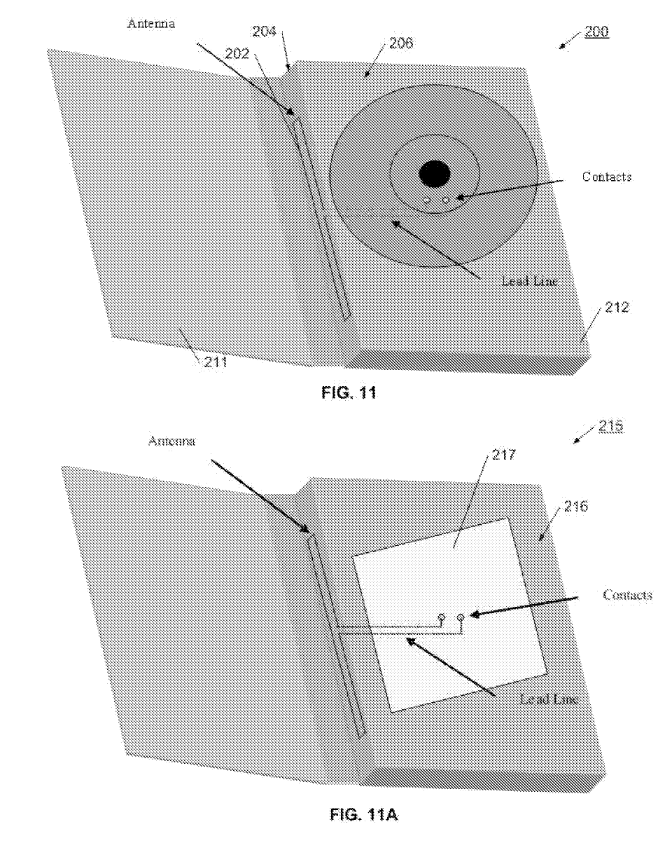

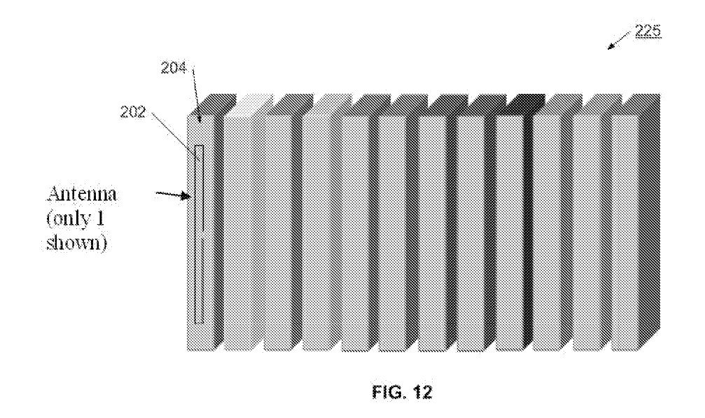

FIG. 11 shows another embodiment 200, in which the antenna 202 can be located on the edge 204 of a case 206, or alternately on a rib inside the case, but in the same plane as the case edge 204. Edge 204 is often referred to as the spine of the case, and is positioned to allow a top cover piece 211 to hinge relative to a bottom cover piece 212. In the ISM band (900 to 930 MHz), a ¼ folded dipole antenna is approximately 6.45 inches in overall length, which fits on the edge of many current optical disc cases which are approximately 7.5 inches long. One advantage of locating the antenna 202 on the edge 204 of the case 206 is that multiple discs can be read when the disc is packaged in a box of 12 or more discs. Since the antenna 202 is now away from the metal layers in the disc and, moreover, is at a right angle to the plane of the optical disc, the metal layers within the disc no longer act like shields to the RF energy. Thus, as illustrated in FIG. 12, discs 225 packaged side by side in a carton or lined up on a shelf can all be read without rearranging the discs.

FIG. 11A shows another case 215 for holding an RF-enabled target device (not shown). As discussed with reference to FIG. 11, the RF-enabled device may be an optical disc, although other types of targets may be used. For example, the target device may be an electronic product. The recess 217 in case 216 is sized to receive the target electronic device. An antenna is positioned on or in the case 216, and couples through a lead-line to a set of contacts. When the target electronic device is pressed into the recess 217, the contacts make electrical connection with a mating set of contacts on the target, which connect to an integrated circuit. The integrated circuit may be an RFID circuit or RFA circuit as previously described. The use of case 215 enables improved RF communications with the RF-enabled target device.

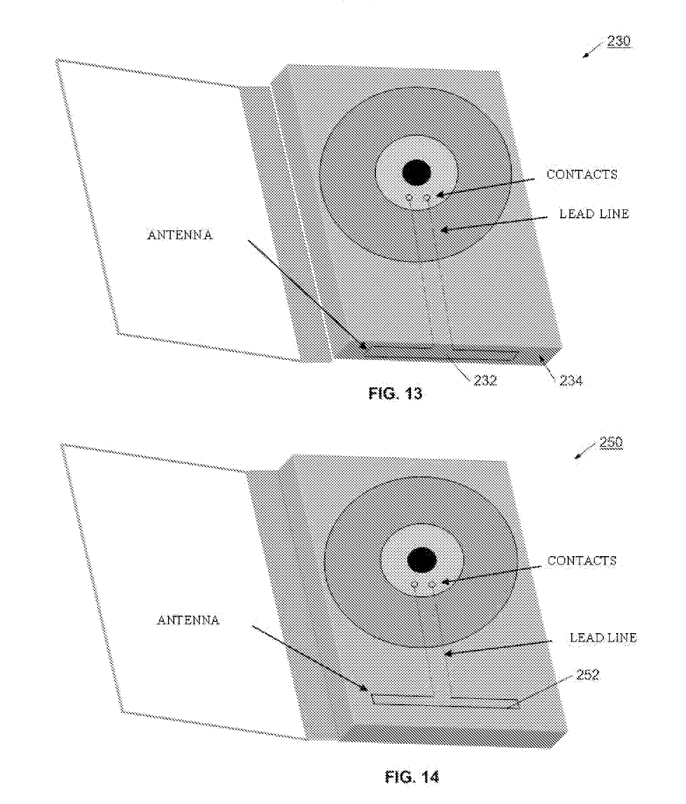

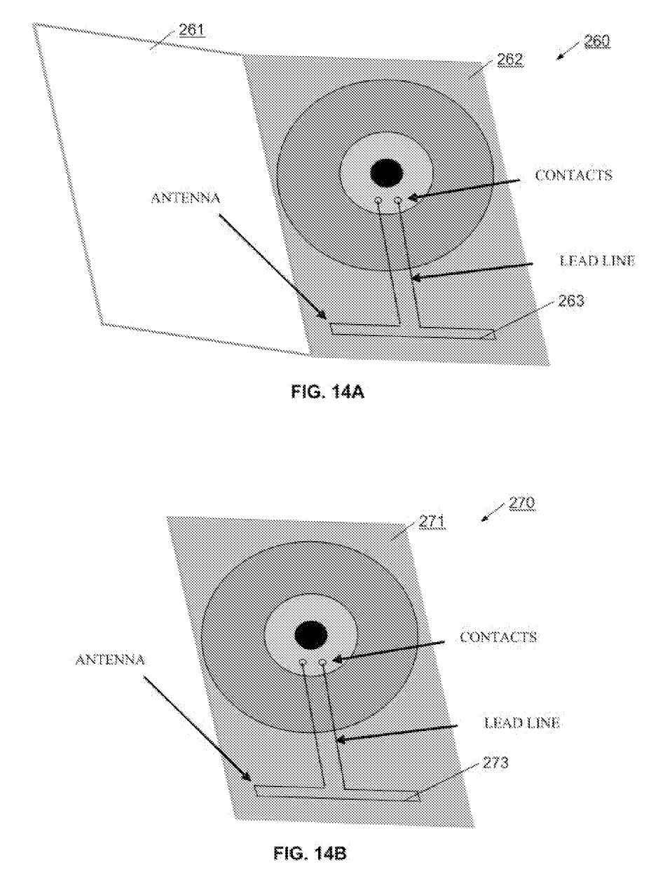

FIG. 13 and 14 illustrate alternative antenna positions on an optical disc case. In FIG. 13, the dipole antenna 232 is located on the lower edge 234 of the case 230 at a right angle to the plane of the disc. As previously described, the RF energy can now reach the antenna without the metallic layers in disc blocking the RF energy. For the example shown, the antenna is most effective when read from the bottom or the top of the case. In addition, multiple cases stacked side by side can all be read without interfering with each other.

In FIG. 14, the dipole antenna 252 is located in the same plane as the optical disc, but is positioned such that it is not blocked by the metallic layers in the disc. This position (offset) allows the RF energy to reach the antenna without being shielded by the reflective layers of the optical disc itself. However, when cases, such as case 250, are stacked side by side, the antennas tend to block each other, making this implementation less effective than those depicted in FIGS. 11 and 12. FIG. 14A shows a case 260 having thin cover pieces 271, which may be made of paper or a thin plastic material. Because the covers are so thin, the spine is also thin, and typically will not support an antenna, or if it does, the antenna would be typically small. As shown in FIG. 14A, an antenna 263 is positioned on or in bottom cover piece 262. Alternatively, the antenna could be positioned in top cover piece 261. As with other arrangements, the antenna couples to the integrated circuit in the optical disc (not shown) through a lead line and contacts. FIG. 14B shows a case 270 having a single cover piece 271, which may be made of paper or a plastic material. Because the cover is so thin, cover 270 typically will not support an antenna on any edge, or if it does, the antenna would be typically small. As shown in FIG. 14B, an antenna 273 is positioned on or in cover piece 271. As with other arrangements, the antenna couples to the integrated circuit in the optical disc (not shown) through a lead line and contacts.

In all of the implementations described in FIGS. 9 to 14, the antenna conductors can be manufactured as part of the case itself. The conductors can be physical wires embedded or bonded to the case, or can be screened on with conductive inks or metals. They can also be implemented on a separate substrate such as polyester, Kapton, or any other suitable material, that is adhesively bonded to the case. If they are adhesively attached as a separate substrate, with the appropriate adhesive, then they can be removed after activation which can be an advantage due to privacy concerns. Note that in all of these examples that any suitably effective antenna geometry can be used.

Multiple Antennas Associated with Cases

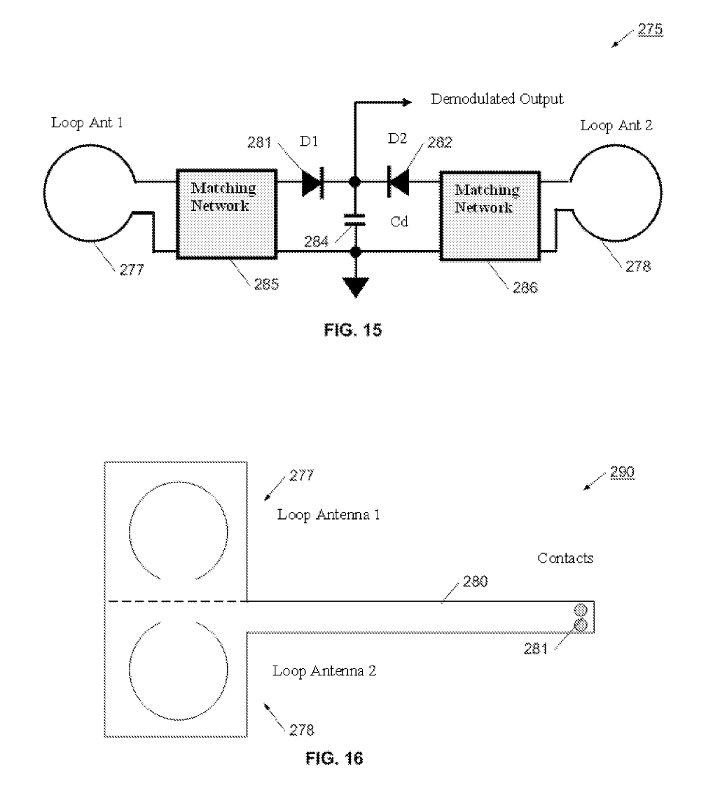

All of the implementations described in FIGS. 1 to 14 are for a single antenna in one plane. Single, round or rectangular, loop antennas tend to be directional with strong lobes perpendicular to the plane of the loop, and nulls in the plane of the conductors. This directionality can be improved by using more than one antenna. A novel approach 275 to combining antennas is shown schematically in FIG. 15. In FIG. 15, two loop antennas 277 and 278 are shown which are connected to their respective demodulator diodes D1 281, and D2 282. Capacitor Cd 284 serves as the demodulator capacitor for both circuits, and the output across the capacitor is the demodulated RF carrier from either or both antennas 277 and 278. Both matching networks 285 and 286 provide a DC return path for their respective demodulated signal via an inductive component.

In practice, the two antennas 277 and 278 can be oriented at right angles to one another, so that nulls do not occur along the plane of a single antenna. The matching networks, diodes D1 281 and D2 282, and the demodulator capacitor Cd 284 can be located on the antenna itself. The demodulated signal which only carries the modulation frequency spectrum, and not the RF carrier, can now be coupled into the IC on the optical disc via a relatively long interconnect 280. An example of this is shown in FIG. 16 where both loop antennas 277 and 278 are printed on a polyester substrate 290 which is coupled into the optical disc via surface contacts 281. An alternative to providing the demodulator diodes 281 and 282 and capacitor Cd 284 on the antennas is to design the IC with extra contacts and locate the diode / capacitor functionality within the IC. Thus, for two antennas the IC can have four contacts for the antenna connections. This configuration can work well when the antenna is physically close to the IC.

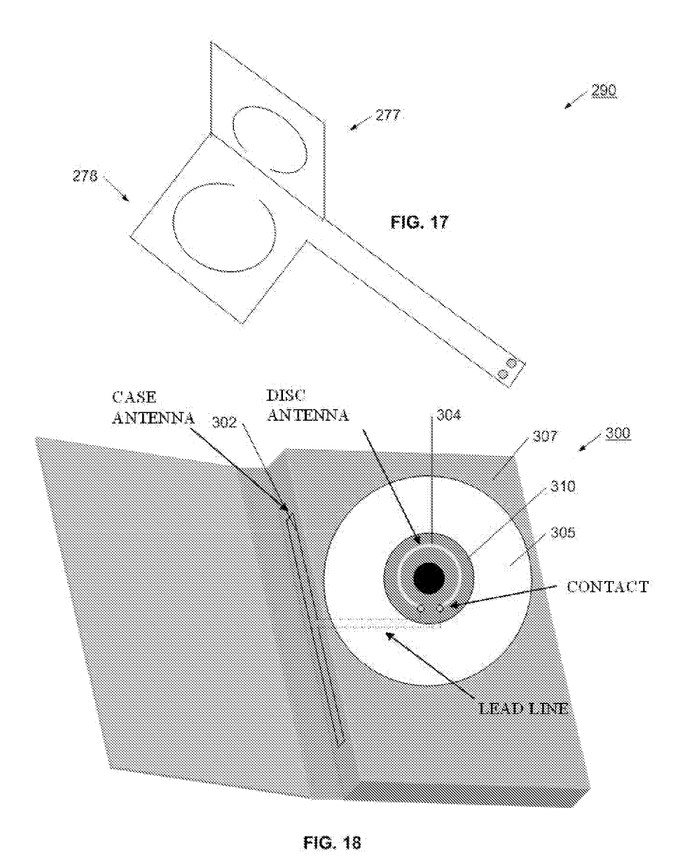

FIG. 16 illustrates a substrate 290 which can be folded along the dotted line to form a two loop antenna 277 and 278 as shown in FIG. 17. This configuration will have a doughnut shaped reception pattern at a right angle to both antenna loops.

An alternate implementation of this concept is shown in FIG. 18. In this dual antenna implementation 300, one antenna 302 is located on the case 307 (a ¼ wave folded dipole is illustrated), and a second antenna 304 is located on the optical disc 305 (a ¼ wave loop is illustrated; however any appropriate antenna geometry can be used). The antenna 302 on the case 307 can be a permanent part of the case 307, or alternatively can be removable. As previously described, the antenna 304 on the optical disc can be part of a label 310, which can be removable, or alternatively the antenna can be permanently attached to the disc, or it can be permanently embedded on or within the optical disc. Either or both of the antennas provide RF communication paths to the IC embedded in the optical disc.

Having dual antennas can facilitate reading or activating a carton of optical discs oriented edgewise on pallets or shelving. Reading or activating discs or simply reading cartons or other packaging at the check-stand can also be enhanced due to the two plane coverage offered by the configuration, which can make it less sensitive to orientation. After a read or activation the antenna on the case can be removed to address privacy or other concerns. The second antenna 304 located on or embedded in the optical disc can be used for additional conditional activation of content on the optical disc, in conjunction with an appropriate device to read and write to the IC.

For example, discs, or more precisely the ICs embedded in the discs, can be read using first antennas located on the edges of the cases containing the discs within a carton on a pallet at a retailer's shipping and receiving dock. A reader at the check-stand can ‘activate’ an individual disc using the first or second antenna. At home the consumer can remove the first antenna (decouple it from the disc) when the case is opened and use the disc in the conventional manner. Later, however, a second antenna embedded in the disc can be used to communicatively couple with other devices (e.g. to conditionally activate features on the disc, affect security schemes, access information stored in the IC, etc.).

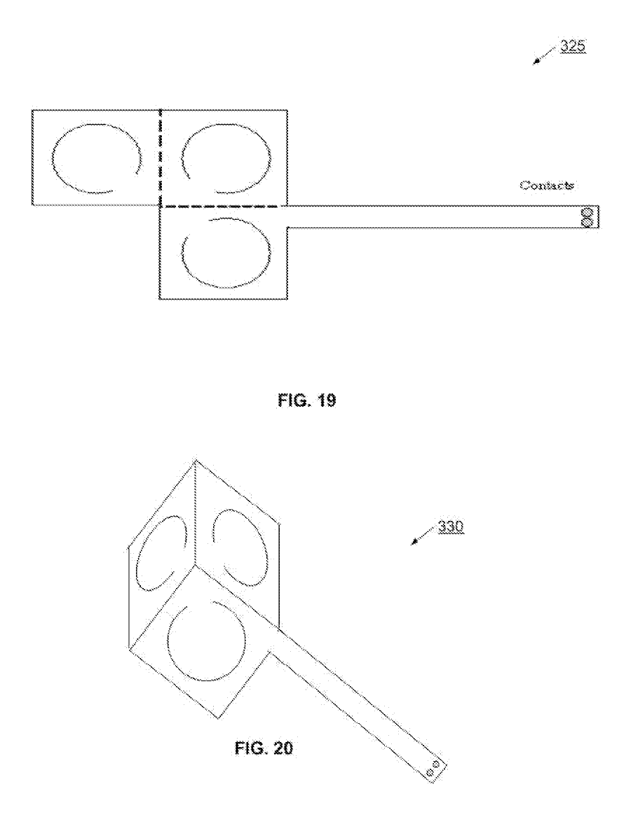

Referring back to FIG. 15, a third antenna can be added simply by duplicating one of the antenna circuits and connecting it in parallel with capacitor Cd 284. One version of this implementation 325 is shown in FIG. 19. When the flat configuration in FIG. 19 is folded in three dimensional space, the triple antenna 330 appears, as shown in FIG. 20.

The three dimensional corner cube arrangement of the triple antenna 330 shown in FIG. 20 can be applied to the corner of any disc (or any target) to be read or activated. Because all three planes can receive RF energy, this configuration is advantageous in terms of positional and rotational sensitivity in all three planes and axes of rotation relative to the reader antenna.

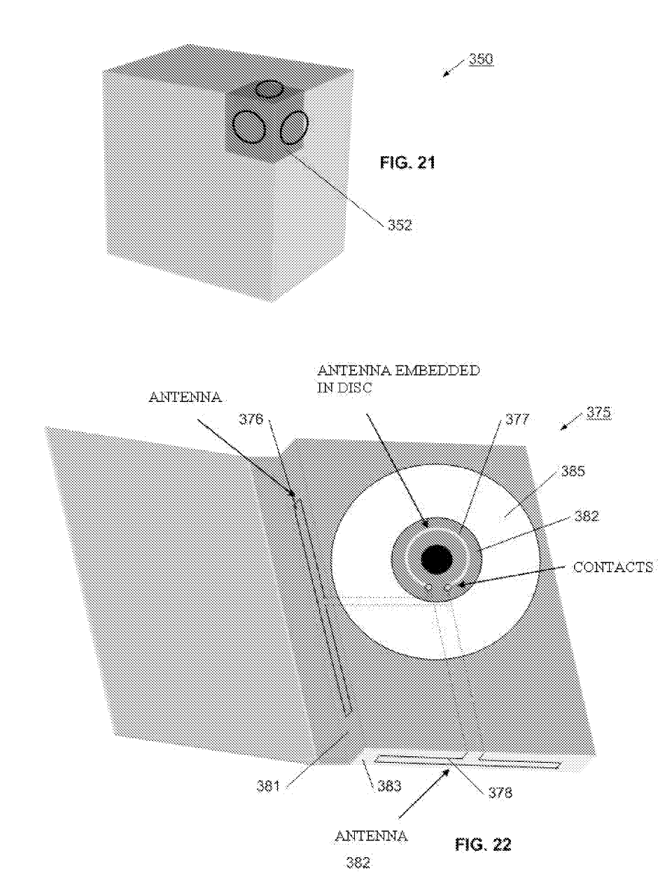

FIG. 21 shows the corner cube antenna 352 applied to a carton 350 where the IC is located on the antenna itself. The corner cube antenna 352 can be printed or screened unto stiff paper or cardboard with suitable dielectric characteristics for the antennas by automated equipment, which then folds the cardboard and automatically applies it to the carton. The location can be on the outside or the inside of the carton 350, assuming that the carton 350 is transparent to the RF frequencies being used. In a similar manner, a dual antenna can be applied to any edge of a carton. Note that internal packing material can also be used, as opposed to the outer container.

A variant of the corner cube can be implemented as shown by the case 375 in FIG. 22. Here, there is an antenna 376, 377, and 378 in each of three orthogonal planes, but none of the antennas are located in a corner. More specifically, antenna 376 is positioned on the spine 381 of the case 375, antenna 377 is on the label 382 of the disc 385, and antenna 378 is on anther edge 383 of the case 375. In order for this implementation to work correctly, the demodulating capacitor Cd shown in FIG. 15 must be split into three separate capacitors. Each of these three capacitors can be located near its respective antenna to keep the RF carrier energy localized to the antenna circuit. The long leads from the two antennas on the edge of the case will therefore only carry the demodulated signal energy.

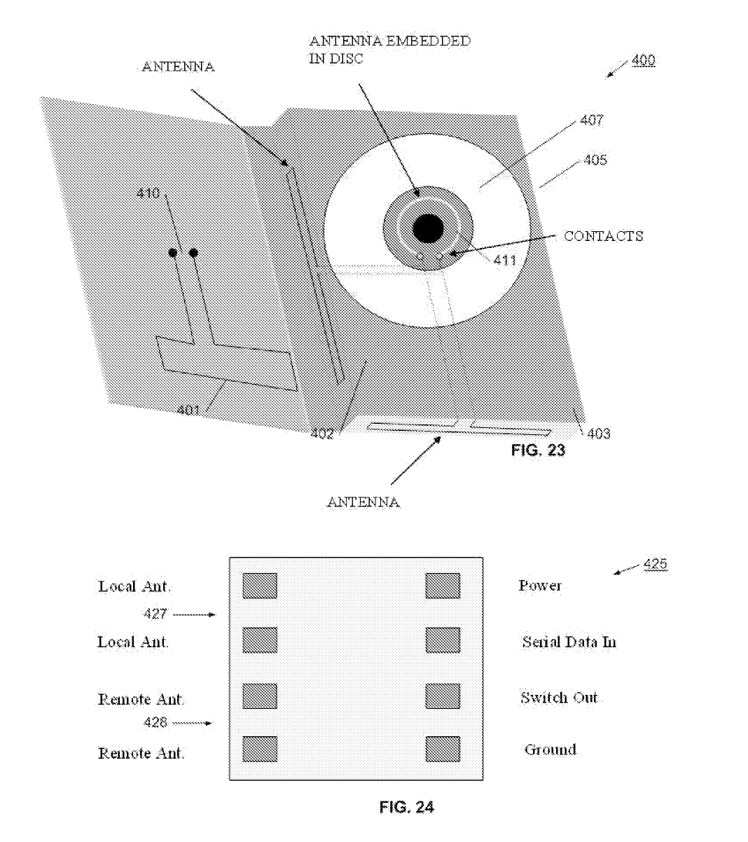

A further implementation of the triple antenna is shown in FIG. 23. In this embodiment, all three antennas 401, 402, and 403 are on the case 400 which contains the optical disc 405. Each antenna can have its own demodulation capacitor. This allows the advantages of a triple antenna for activating the optical disc 405 without requiring any of the antennas to be on or embedded in the disc. However, as illustrated, the disc 405 may have an embedded antenna 407 so that the disc IC may be used independent of the case. The contacts 410 on the case mate to contacts 411 on the disc 405 as previously described.

Modified IC for Use with Antennas

In all of the variations described so far, the antennas all require external demodulator circuits in order to accommodate the relatively long leads between the actual antennas and the IC. However, in the situation of an embedded antenna on the disc as shown in FIG. 18, the lead length between the embedded antenna and the IC is short. In this situation, a modified IC 425, shown in FIG. 24, can be used. For the modified IC 425, one set of contacts 427 is used for the embedded antenna which is close to IC. These contacts are labeled “Local Ant.” This set of contacts 427 can be used to interface the modulated RF carrier directly to the internal IC circuitry. The IC can be designed so that there is an internal demodulator, or equivalent function within the IC. In addition, an internal amplifier can be used to increase the sensitivity the RF energy for this antenna, which can increase the receive range. Only one antenna can be connected to the leads labeled “Local Ant.” The second set of contacts 428 is labeled “Remote Ant.” This set of contacts 428 can be used to connect the remaining remote antennas that have demodulators as part of their circuit to the IC. This set of contacts can be used with one or more antennas. The remote set of antenna contacts on the IC require that the signal coming in has been demodulated either on the antennas, or by an alternate demodulator in a separate IC.

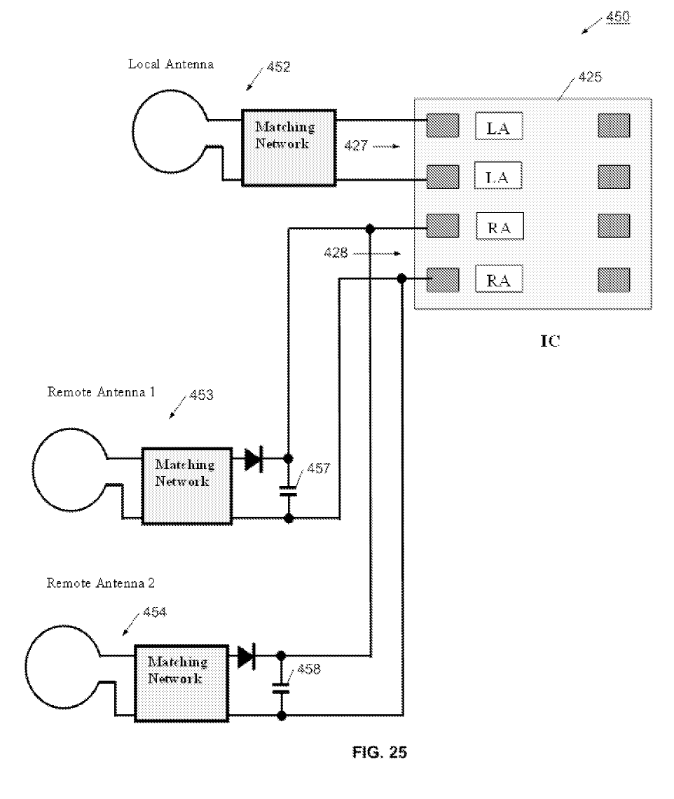

FIG. 25 is schematic representation 450 of how the modified IC 425 can be used with both local 452 and remote antennas 453 and 454. In FIG. 25, each of the remote antennas 453 and 454 is shown with its own demodulator capacitor 457 and 458. This can be necessary if these two antennas are physically located away from each other, and have separate leads back to the IC 425. However, if the two remote antennas 453 and 454 are near each other, they can share a single demodulator capacitor, and have a single lead back to the IC.

Although the present invention has been discussed in considerable detail with reference to certain preferred embodiments, other embodiments are possible. The steps disclosed for the present methods are not intended to be limiting nor are they intended to indicate that each step depicted is essential to the method, but instead are exemplary steps only. Therefore, the scope of the appended claims should not be limited to the description of preferred embodiments contained in this disclosure. All references cited herein are incorporated by reference to their entirety.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. A wireless system for a target, comprising:
a target device;
an integrated circuit attached to the target;
a first antenna connected to the integrated circuit and constructed to receive a wireless signal;
a demodulator adjacent the antenna for demodulating the wireless signal; and
a lead line connecting the demodulator to the integrated circuit.

2. The wireless system according to claim 1, wherein the wireless signal is an RF signal.

3. The wireless system according to claim 1, wherein the wireless signal is an RF signal operating at an RFID frequency or a near field communication frequency.

4. The wireless system according to claim 1, wherein the first antenna is removable.

5. The wireless system according to claim 1, further comprising:
a second antenna orthogonal to the first antenna and connected to the integrated circuit;
a second demodulator adjacent the antenna for demodulating a wireless signal; and
a second lead line connecting the demodulator to the integrated circuit.

6. The wireless system according to claim 5, wherein the first antenna or the second antenna is removable.

7. The wireless system according to claim 5, wherein both the first antenna and the second antenna are removable.

8. The wireless system according to claim 5, further comprising:
a third antenna orthogonal to the first antenna and the second antenna, and connected to the integrated circuit;
a third demodulator adjacent the antenna for demodulating a wireless signal; and
a third lead line connecting the demodulator to the integrated circuit.

9. The wireless system according to claim 8, wherein any one of the first antenna, second antenna, or third antenna is removable.

10. The wireless system according to claim 8, wherein any two of the first antenna, second antenna, or third antenna are removable.

11. The wireless system according to claim 8, wherein the first antenna, second antenna, and third antenna are all removable.

12. The wireless system according to claim 1, further comprising a second antenna orthogonal to the first antenna and connected to the integrated circuit.

13. The wireless system according to claim 1, further comprising a second antenna orthogonal to the first antenna and connected to the demodulator.

14. The wireless system according to claim 1, wherein the demodulator comprises a diode.

15. The wireless system according to claim 14, wherein the demodulator comprises a capacitor.

16. The wireless system according to claim 1, wherein the demodulator couples to a matching circuit.

17. The wireless system according to claim 1, wherein the integrated circuit is on a surface of the target.

18. The wireless system according to claim 1, wherein the integrated circuit is in the target.

19. The wireless system according to claim 1, wherein the integrated circuit is embedded in the target.

20. The wireless system according to claim 1, wherein the integrated circuit is in a label that is attached to the target.

21. The wireless system according to claim 1, wherein the integrated circuit is on a label that is attached to the target.

22. The wireless system according to claim 1, wherein the target is an optical disc.

23. The wireless system according to claim 1, wherein the target is an electrical device.

24. An antenna for an RF system, comprising:
an antenna;
an RF demodulator adjacent the antenna; and
a lead line for transmitting demodulated data.

25. The antenna according to claim 24, wherein the RF demodulator is on the antenna.

26. The antenna according to claim 24, wherein the lead line is constructed to couple to an integrated circuit.

27. The antenna according to claim 26, wherein the lead line is a long lead line.

28. The antenna according to claim 26, wherein the lead line is longer than about 2 inches.

29. The antenna according to claim 24, wherein the RF demodulator comprises a diode demodulator.

30. The antenna according to claim 29, wherein the RF demodulator comprises a capacitor.

31. The antenna according to claim 24, wherein the RF demodulator couples to a matching circuit.

32. The antenna according to claim 24, further including a substrate, and the antenna is on the substrate

33. The antenna according to claim 32, wherein the substrate is foldable to change orientation of the antenna.

34. The antenna according to claim 32, wherein the substrate is foldable to tune the antenna.

35. The antenna according to claim 32, wherein the substrate further comprises attachment means to a target, the target having an associated integrated circuit.

36. The antenna according to claim 35, wherein the attachment means enables the substrate to be removable from the target.

37. The antenna according to claim 24, wherein the RF operates at an RFID frequency or a near field communication frequency.

38. A multi-antenna device for an RF system, comprising:
a plurality of antennas;
an RF demodulator adjacent to at least one of the antennas; and
a lead line coupled to each RF demodulator, each lead line for transmitting demodulated data.

39. The antenna according to claim 38, wherein the RF demodulator is on each respective antenna.

40. The antenna according to claim 38, wherein each RF demodulator comprises a respective diode demodulator.

41. The antenna according to claim 38, further including a substrate, and the plurality of antennas are on the substrate.

42. The antenna according to claim 41, wherein the substrate is foldable to orient one of the antennas to be orthogonal to another antenna.

43. The antenna according to claim 41, wherein the substrate is foldable to tune one or more of the antennas.

44. The antenna according to claim 41, wherein the substrate further comprises attachment means to a target, the target having an associated integrated circuit.

45. The antenna according to claim 38, wherein the plurality of antennas includes two antennas.

46. The antenna according to claim 38, wherein the plurality of antennas includes three antennas.

47. The antenna according to claim 38, wherein the RF operates at an RFID frequency or a near field communication frequency.
